(19) United States
(12) Patent Application Publication
(10) Pub. No.: US 2004/0044741 A1
(43) Pub. Date: Mar. 4, 2004

(54) Disc specific cookies for web DVD

(76) Inventors: Declan Patrick Kelly, Eindhoven (NL); Warner Ten Kate, Waalre (NL)

Correspondence Address: PHILIPS INTELLECTUAL PROPERTY & STANDARDS, P.O. BOX 3001, BRIARCLIFF MANOR, NY, 10510, US

(21) Appl. No.: 10/232,107

(22) Filed: Aug. 30, 2002

(51) Int. Cl. G06F 15/16

(52) U.S. Cl. 709/217

(57) ABSTRACT

A method, system, and computer code for processing a cookie relating to a WebDVD system that includes a DVD device on which a DVD disc is running. The DVD device is linked by a communication link to a web site targeted by the DVD disc, wherein the cookie had been generated by the WebDVD system as specified by a cookie-generation command received from the web site. The WebDVD system adds to the cookie a DVD extension string that includes content associated with the DVD disc. The cookie may be screened such that if the same or other DVD disc is subsequently running on the DVD device that is linked to a web site targeted by the same or other DVD disc, then the cookie is sent to the web site if the DVD extension string includes the content associated with the same or other DVD disc.

### BACKGROUND OF THE INVENTION

1. Technical Field

The present invention relates to a method, system, and computer code for running a DVD disc having a link to web content of a web site, wherein the web content is directly related the content on the DVD disc, and wherein the system adds a DVD extension string to a cookie to form an extended cookie and subsequently uses the DVD extension string to determine whether to transmit the cookie back to the web site.

2. Related Art

WebDVD is a technology in which a Digital Versatile Disc or Digital Video Disc (DVD) disc is linked to web content of a web site, wherein the web content is directly related the content on the DVD disc. The content on the DVD disc may include video and audio content. WebDVD combines Digital Versatile Disc or Digital Video Disc (DVD) with internet technology, thus providing fast access to high-quality video and audio data offered by DVD along with advantages offered by internet technology (e.g., interactivity, dynamic updates, etc.). For example, WebDVD enables local DVD to be enhanced with HTML web pages.

With internet technology, a cookie is a text string within a text file, typically called a “cookie file” and is stored on the web user's machine (e.g., computer; DVD device, etc.). Information on cookies may be obtained from RFC2965 (see http://www.ietf.org/rfc/rfc2965.txt).

A cookie is used by a web server of a web site to identify the web user. In response to a request from a user's web browser to a web site for web content from the web site, the web server sends a “Set-Cookie” command (with included parameters) to the browser. In response, the browser generates a cookie based on the parameters in the “Set-Cookie” command and adds the generated cookie to the cookie file. The cookie file may comprise one or more cookies and each such cookie results from a “Set-Cookie” command from a web site. Thus different cookies in the cookie file correlate with different web sites. When the web browser subsequently requests a file or web page from the same web server that previously sent the “Set-Cookie” command to the user's machine (which resulted in generation of a specific cookie), the browser sends a copy of the specific cookie back to the same web server along with the request for said file or web page. Thus, the server sends the user a cookie and the user's browser sends back the cookie whenever the user requests another file or web page from the same server. In this manner, the same server is able to determine that the user has visited its web site before and can customize the web site for the specific user. For example, an internet shopping web site may use a cookie to keep track of user-supplied data (e.g., name, address, etc.) and of ordering characteristics of the specific user.

A particular cookie is returned only to the server that sent the particular cookie to the browser, which seems to imply that a particular cookie cannot be used to track the user's behavior over a number of different web sites. In practice, however, many web sites include banner advertisements from a web advertising agency and said many web sites embed links to the web advertising agency in their web pages. Thus, when the user goes to one of said many web sites, the browser also links the user to a web site of the web advertising agency. The embedded link enables the web advertising agency to store a cookie in the user's machine. Since the web advertising agency is similarly linked to the other web sites of said many web sites, the web advertising agency can track the user's visitations across said many web sites. This enables advertisements to be targeted to the user based on the web sites visited, which may be viewed as an invasion of privacy. Similarly, when a WebDVD user plays multiple discs that are linked to one or more web sites, cookies enable a web server to track the discs that the user has played, which may likewise be viewed as an invasion of privacy.

Thus with respect to WebDVD, there is a need to prevent or inhibit web sites from tracking the navigation of a WebDVD user on the Internet. There is also a need to prevent or inhibit a web site from tracking the discs that a given user has played.

### SUMMARY OF THE INVENTION

In first embodiments, the present invention provides a method for extending a cookie, comprising:

running, by the WebDVD system, a DVD disc on a DVD device that is comprised by the WebDVD system, wherein the DVD device is linked by a communication link to a web site that is targeted by the DVD disc;

receiving during said running, by the WebDVD system from the web site, a cookie-generation command to generate a cookie;

generating, by the WebDVD system, the cookie as specified by the cookie-generation command;

adding, by the WebDVD system, a DVD extension string to the cookie to form an extended cookie, wherein the DVD extension string includes specific content associated with the DVD disc; and

storing the extended cookie in a readable memory device comprised by the WebDVD system.

In second embodiments, the present invention provides a method for screening a cookie, comprising:

retrieving a cookie from a readable memory device of a WebDVD system that includes a DVD device, wherein the cookie includes a DVD extension string; and

precluding transmission of the cookie to a web site targeted by a DVD disc that is running on the DVD device if the DVD extension string does not includes specific content associated with the DVD disc, wherein the DVD device is linked by a communication link to the web site.

In third embodiments, the present invention provides a network, comprising a WebDVD system for extending a cookie, wherein the WebDVD system is adapted to:

run a DVD disc on a DVD device that is comprised by the WebDVD system, wherein the DVD device is linked by a communication link to a web site that is targeted by the DVD disc;

receive from the web site, while the DVD disc is running on the DVD device, a cookie-generation command to generate a cookie;

generate the cookie as specified by the cookie-generation command;

add a DVD extension string to the cookie to form an extended cookie, wherein the DVD extension string includes specific content associated with the DVD disc; and

store the extended cookie in a readable memory device comprised by the WebDVD system.

In fourth embodiments, the present invention provides a network, comprising a WebDVD system for screening a cookie, wherein the WebDVD system is adapted to:

retrieve a cookie from a readable memory device of a WebDVD system that includes a DVD device, wherein the cookie includes a DVD extension string; and

preclude transmission of the cookie to a web site targeted by a DVD disc that is running on the DVD device if the DVD extension string does not includes specific content associated with the DVD disc, wherein the DVD device is linked by a communication link to the web site.

In fifth embodiments, the present invention provides a computer program product, comprising a computer usable medium having a computer readable program code embodied therein for extending a cookie, said computer code embedded within a readable storage device of a WebDVD system, said computer code comprising an algorithm adapted to:

run a DVD disc on a DVD device that is comprised by the WebDVD system, wherein the DVD device is linked by a communication link to a web site that is targeted by the DVD disc; receive from the web site, while the DVD disc is running on the DVD device, a cookie-generation command to generate a cookie;

generate the cookie as specified by the cookie-generation command;

add a DVD extension string to the cookie to form an extended cookie, wherein the DVD extension string includes specific content associated with the DVD disc; and

store the extended cookie in a readable memory device comprised by the WebDVD system.

In sixth embodiments, the present invention provides a computer program product, comprising a computer usable medium having a computer readable program code embodied therein for screening a cookie, said computer code embedded within a readable storage device of a WebDVD system, said computer code comprising an algorithm adapted to:

retrieve a cookie from a readable memory device of a WebDVD system that includes a DVD device, wherein the cookie includes a DVD extension string; and

preclude transmission of the cookie to a web site targeted by a DVD disc that is running on the DVD device if the DVD extension string does not includes specific content associated with the DVD disc, wherein the DVD device is linked by a communication link to the web site.

In seventh embodiments, the present invention provides a cookie embedded within a readable memory device of a WebDVD system that includes a DVD device on which a DVD disc is running, said cookie comprising a DVD extension string, wherein the cookie is not to be transmitted to a web site if the DVD extension string does not include specific content associated with the DVD disc, and wherein the web site is targeted by the DVD disc and is linked by a communication link to the DVD disc.

The present invention provides a method and associated software that prevents or inhibits web sites from tracking the navigation of a WebDVD user on the Internet. The present invention also provides a method and associated software that prevents or inhibits a web site from tracking the discs that a given user has played.

### BRIEF DESCRIPTION OF THE DRAWINGS

FIG. 1 depicts a WebDVD system linked to a web site by a communication link such that the WebDVD system includes a DVD device, in accordance with embodiments of the present invention.

FIG. 2 depicts the DVD device of FIG. 1 on which a DVD disc is placed, in accordance with embodiments of the present invention.

FIG. 3 depicts the DVD disc of FIG. 2, in accordance with embodiments of the present invention.

FIG. 4 depicts a cookie file, in accordance with embodiments of the present invention.

FIG. 5 depicts a normal cookie, in accordance with embodiments of the present invention.

FIG. 6A depicts the normal cookie of FIG. 5 extended with a prefix extension string, in accordance with embodiments of the present invention.

FIG. 6B depicts the normal cookie of FIG. 5 extended with a suffix extension string, in accordance with embodiments of the present invention.

FIG. 6C depicts the normal cookie of FIG. 5 extended with an inner extension string, in accordance with embodiments of the present invention.

FIG. 7 is a flow chart depicting adding a DVD extension string to a normal cookie during processing of the normal cookie, in accordance with embodiments of the present invention.

FIG. 8 is a flow chart depicting exclusion of access of a targeted web site to an extended cookie based on the DVD extension string added to the cookie, in accordance with embodiments of the present invention.

FIG. 9 is a table of specific content associated with the DVD, in accordance with embodiments of the present invention.

### DETAILED DESCRIPTION OF THE INVENTION

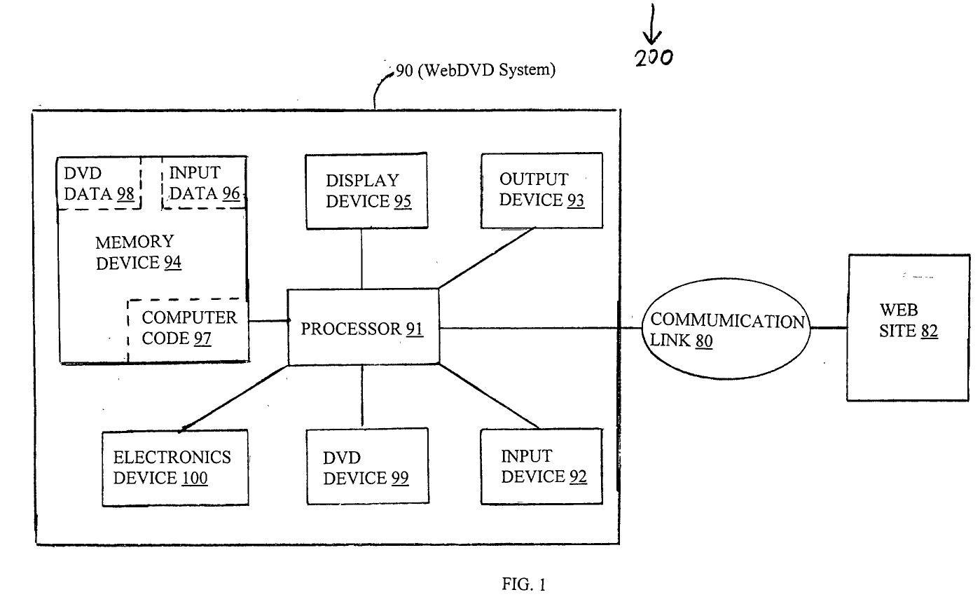

FIG. 1 depicts a network 200, comprising a WebDVD system 90 and a web site 82, in accordance with embodiments of the present invention. The WebDVD system 90 is linked to the web site 82 by a communication link 80. “DVD” stands for Digital Versatile Disc or Digital Video Disc. The communication link 80 may comprise the Internet, an Intranet, etc., to which the web site 82 is linked. The web site 82 generates web content (e.g., web pages) which is understood herein to include any type of internet-based content, including any content available on a server connected to the Internet. The web site 82 may comprise, inter alia, any information stored on a internet connected server.

The WebDVD system 90 comprises a processor 91, a DVD device 99, an electronics device 100, an input device 92, a memory device 94, a display device 95, and an output device 93. The processor 91 is coupled to the communication link 80, the DVD device 99, the electronics device 100, the input device 92, the memory device 94, the display device 95, and the output device 93. In various embodiments, one or more of the preceding devices may be absent.

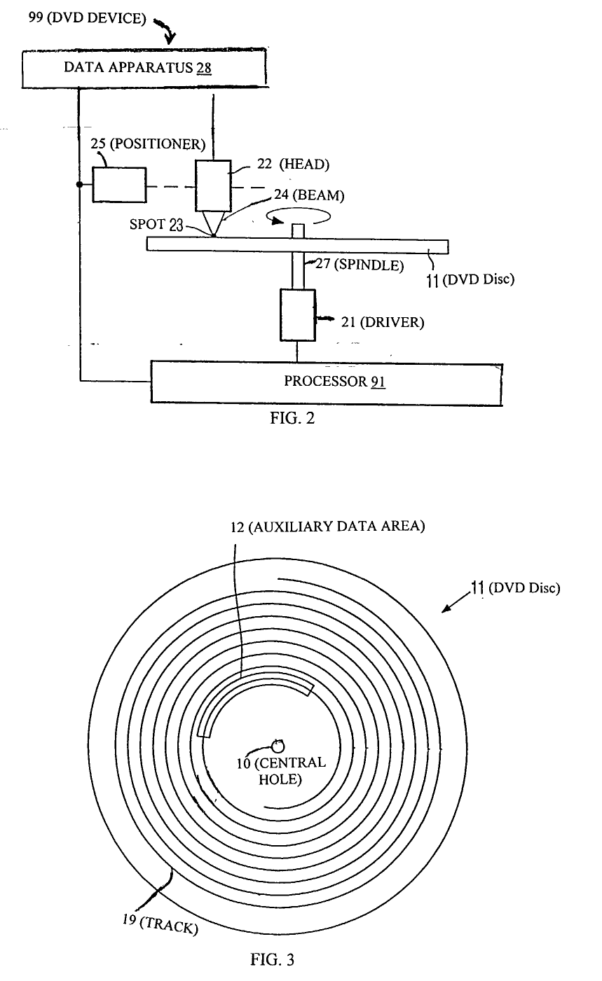

The DVD device 99 is a device or apparatus that reads and/or writes on a DVD disc. The DVD device 99 is shown in FIG. 2 as holding a DVD disc 11 and is described infra. The DVD disc 11 is shown in FIG. 3 and is described infra.

In FIG. 1, the electronics device 100 is one or more electronic devices that may be used in conjunction with the DVD device 99 and may be a component of an integrated electronics device (e.g., a consumer electronics device). Examples of pertinent consumer electronics devices include, inter alia, a video game player (e.g., Sony Playstation 2®), a DVD-VHS device that includes the DVD device 99 coupled to the electronics device 100 representing a VHS video cassette recorder, a stereo system that includes the DVD device 99 coupled the electronics device 100 representing stereo components. In a given embodiment, the electronics device 100 may be present or absent in the WebDVD system 90.

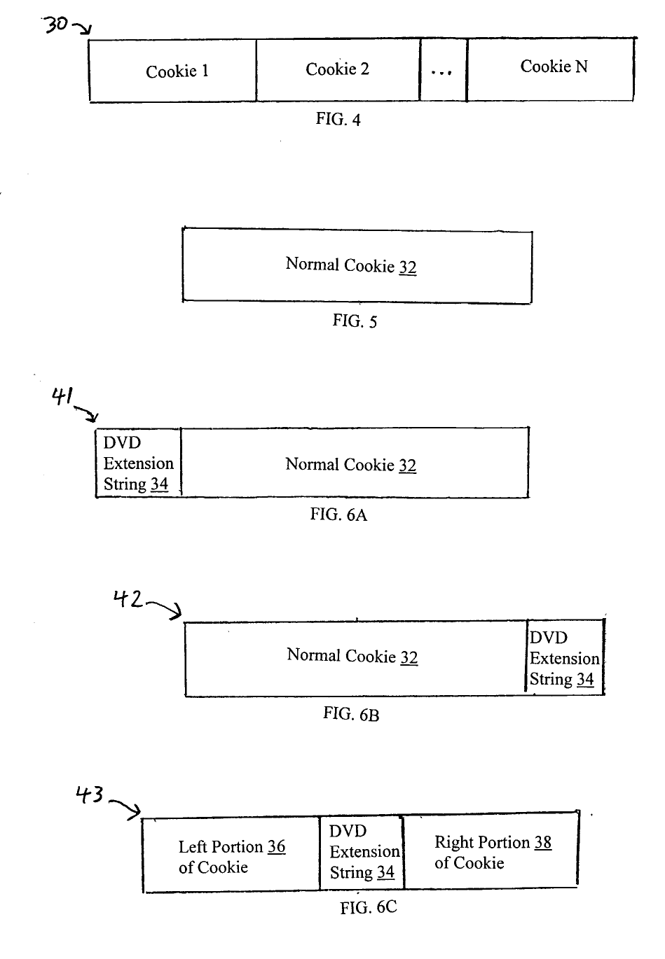

The memory device 94 may be, inter alia, a hard disk, a floppy disk, a magnetic tape, an optical storage (e.g., DVD or compact disc(CD): with Read/Write and/or Read Only capabilities), a dynamic random access memory (DRAM), a flash memory, a read-only memory (ROM), etc. The memory device 94 includes software, namely a computer code 97. The computer code 97 includes an algorithm for adding a DVD extension string to a cookie to form an extended cookie and subsequently uses the DVD extension string to determine whether to transmit the cookie to a web site as will be discussed infra in conjunction with FIGS. 4, 5, and 6A-6C. The processor 91 executes the computer code 97. The memory device 94 may also include input data 96 which includes input used by the computer code 97. The memory device 94 may additionally include DVD data 98 which may comprise, inter alia, DVD data derived from a web page of a web site, DVD data derived from a DVD disc (e.g., the DVD disc 11 shown in FIGS. 2 and 3 described infra), etc.

The memory device 94 (or one or more additional memory devices not shown in FIG. 1) may be embodied as a readable medium for storing program code and data, and for reading program code and data. The memory device 94 may be, inter alia, a computer usable medium, a computer readable medium, a program storage device, a readable memory device, a data storage device, etc. The memory device 94 may have a readable program code (e.g., a computer readable program code) embodied therein and/or having other data stored therein, wherein the computer readable program code comprises the computer code 97. Generally, a computer program product (or, alternatively, an article of manufacture) of the computer system 90 may comprise said memory device 94.

The display device 95 is any device having a display screen (e.g., a television, a monitor, etc.).

The input device 92 may be, inter alia, a keyboard, a mouse, a joystick combinations thereof, etc.

The output device 93 represents one or more output devices such as, inter alia, a printer, a plotter, a computer screen, a magnetic tape, a removable hard disk, a floppy disk, etc. The output device 93 may display output from the computer code 97. The output device 93 may also express output from a DVD disc that is running in the DVD device 99. Accordingly, the output device may be an audible device such as a speaker. Of course, the DVD device 99 itself may include a speaker for audibly expressing subject content being played on a DVD disc. In a given embodiment, the output device 93 may be present or absent in the WebDVD system 90.

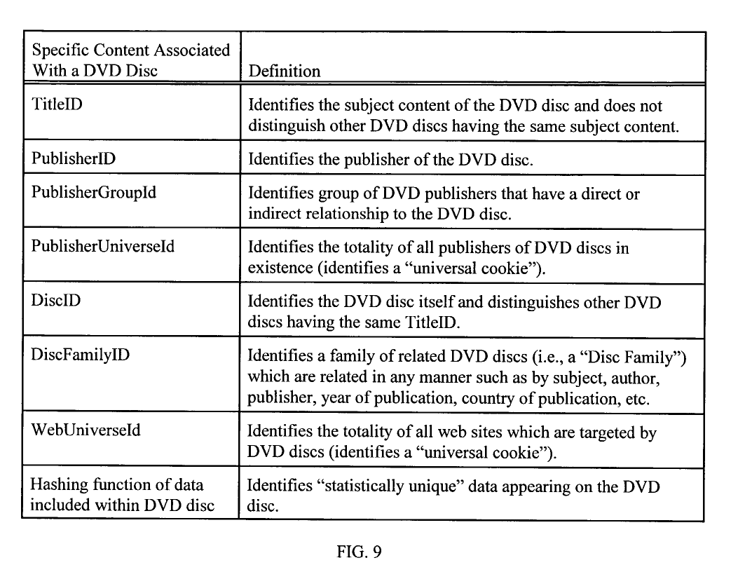

While FIG. 1 shows the WebDVD system 90 as a particular configuration of hardware and software, any configuration of hardware and software, as would be known to a person of ordinary skill in the art, may be utilized for the purposes stated in this patent application in conjunction with the particular computer system 90 of FIG. 9. For example, one or more additional multiple memory devices may be used instead of the single memory device 94. As another example, various components WebDVD system 90 may be directly coupled to each other (e.g., the DVD device 99 and the electronics device 100 may be directly coupled to each other such as in a single device).

The WebDVD system 90 may be configured in accordance with various embodiments including, inter alia, a DVD player embodiment, a computer system embodiment, and an integrated device embodiment.

In the DVD player embodiment, the WebDVD system 90 comprises a DVD player which includes: the DVD device 99, the processor 91, the input device 92, and the memory device 94. The DVD player may also internally include the display device 95, or be coupled to the display device 95 wherein the display device 95 is external to the DVD player yet is within the WebDVD system 90. As an external display device, the display device 95 may be a television or a monitor.

In the computer system embodiment, the WebDVD system 90 comprises a computer system which includes: the processor 91, the input device 92, the memory device 94, the output device 93, and the display device 95 (e.g., a computer monitor). The computer system may also internally include the DVD device 99, or be coupled to the DVD device 99 wherein the DVD device 99 is external to the computer system yet is within the WebDVD system 90.

In the integrated device embodiment, the WebDVD system 90 comprises an integrated device that includes: the DVD device 99, the electronics device 100 in the form of a consumer electronics device, the processor 91, the input device 92, and the memory device 94. The integrated device may also internally include the display device 95, or be coupled to the display device 95 wherein the display device 95 is external to the integrated device yet is within the WebDVD system 90. As an external display device, the display device 95 may be a television or a monitor. As stated supra, the integrated device may comprise a video game player, a DVD-VHS device, a stereo system, etc.

FIG. 2 depicts the DVD device 99 of FIG. 1 on which a DVD disc 11 is placed, in accordance with embodiments of the present invention. The web site 82 of FIG. 1 is targeted by the DVD disc 11, which means that the WebDVD system 90 may have access to web content relating to the DVD disc 11 only when the DVD disc 11 in running on the DVD device 99. The DVD device 99 may be used for reading the DVD disc 11, writing to the DVD disc 11 (if the DVD disc 11 is a rewritable disc), or both. Accordingly, a read/write head 22 reads or writes data at the spot 23 on the DVD disc 11. The driver 21 rotates the DVD disc 11 on a spindle 27, and a positioner 25 moves the head 22 radially between the center and outer boundary of the DVD disc 11. When the DVD device 99 is used for reading the DVD disc 11, the head 22 serves as a read head and the data apparatus 28 retrieves the data read by the head 22. When the DVD device 99 is used for writing to the DVD disc 11, the head 22 serves as a write head and the data apparatus 28 distributes data from a data source (not shown) to the head 22 for subsequent writing. The DVD device 99 depicted in FIG. 2 is merely exemplary, and may be varied in any manner known to one of ordinary skill in the art for reading a DVD disc or writing to a DVD disc.

FIG. 3 depicts the DVD disc 11 of FIG. 2, in accordance with embodiments of the present invention. The DVD disc 11 has a central hole 10 that fits on the spindle 27 of FIG. 2. The DVD disc 11 is arranged in accordance with a spiral pattern of turns constituting substantially parallel tracks as illustrated by track 19. Information may be represented on the DVD disc 11 by optically detectable marks recorded along the track, e.g. pits and lands. The DVD disc 11 may have special regions or areas for recording particular types of information. For example, an auxiliary data area 12 may be used to store data other than the DVD subject content (e.g., movies) intended to be played by the WebDVD user. An example of such auxiliary data includes tables, pointers, format identification for the DVD subject content intended to be played by the WebDVD user, etc. The DVD subject content intended to be played by the WebDVD user may include video information, audio information, or both.

As will be illustrated infra in conjunction with FIGS. 4, 5, and 6A-6C, the present invention provides a method, system, and associated software that prevents or inhibits web sites from tracking the navigation of a WebDVD user on the Internet or on an Intranet. Said method, system, and associated software relates to adding a DVD extension string to a normal cookie as will be discussed infra. The reader is referred to the “Related Art” section, discussed supra, for a background discussion of cookies. The “Set-Cookie” command referred to in the “Related Art” section is viewed in the context of the present invention as an embodiment of a cookie-generation command. In response to a request from the computer code 97 to a web site for web content from the web site 82, the web site 82 sends a cookie-generation command (e.g., a “Set-Cookie” command) with included parameters to the computer code 97. In response, the computer code 97 generates a cookie based on the parameters in the cookie-generation command and adds the generated cookie to the cookie file stored in the memory device 94.

FIG. 4 depicts a cookie file 30, in accordance with embodiments of the present invention. The cookie file 30 includes N cookies (Cookie 1, Cookie 2, . . . , Cookie N), wherein N is at least 1. Each such cookie comprises text strings called “attributes.” The attributes are derived from the parameters in the cookie-generation command. A normal cookie may comprise some or all of the following attributes:

the name of the cookie;

the value of the cookie, which may contain data such as state information related to the current session and/or previous sessions;

the expiration date of the cookie, which defaults to the end of the current session in which the user is connected to the web browser;

the domain name, which contains the address of the web site that sent the cookie to the web browser and which can be set to permit multiple servers in the same subdomain that includes the server to receive the cookie from the browser;

the path, which identifies the Universal Resource Locator (URL) or Universal Resource Identifier (URI) or Universal Resource Name (URN) path identifier within which the cookie is valid and which defaults to the URL, URI, or URN path of the web site that created the cookie; and

secure, which can be used to specify that the cookie should be sent to the web site only under a secure connection to the server (e.g., SSL).

FIG. 5 depicts a normal cookie 32, in accordance with embodiments of the present invention. The computer code 97 (see FIG. 1) adds a DVD extension string 34 (see FIGS. 6A-6C) to the normal cookie 32 to form an “extended cookie” wherein the DVD extension string 34 includes specific content associated with the DVD disc 11 that is running on the DVD device 99 of the WebDVD system 90 (see FIGS. 1 and 2). The DVD extension string 34 may take the form of a prefix extension string, a suffix extension string, and an inner extension string depending on where the DVD extension string is added to the normal cookie 32 to form the extended cookie, as shown in the extended cookie of FIG. 6A, FIG. 6B, and FIG. 6C, respectively.

FIG. 6A depicts an extended cookie 41 as the normal cookie 32 of FIG. 5 extended with the DVD extension string 34 positioned as a prefix extension string, in accordance with embodiments of the present invention. In FIG. 6A, the DVD extension string 34 is positioned as a prefix that heads the normal cookie 32.

FIG. 6B depicts an extended cookie 42 as the normal cookie 32 of FIG. 5 extended with the DVD extension string 34 positioned as a suffix extension string, in accordance with embodiments of the present invention. In FIG. 6B, the DVD extension string 34 is positioned as a suffix that trails the normal cookie 32.

FIG. 6C depicts an extended cookie 43 as the normal cookie 32 of FIG. 5 extended with the DVD extension string 34 positioned as an inner extension string, in accordance with embodiments of the present invention. In FIG. 6C, the DVD extension string 34 is sandwiched between a left portion 36 of the normal cookie 32 and a right portion 36 of the normal cookie 32.

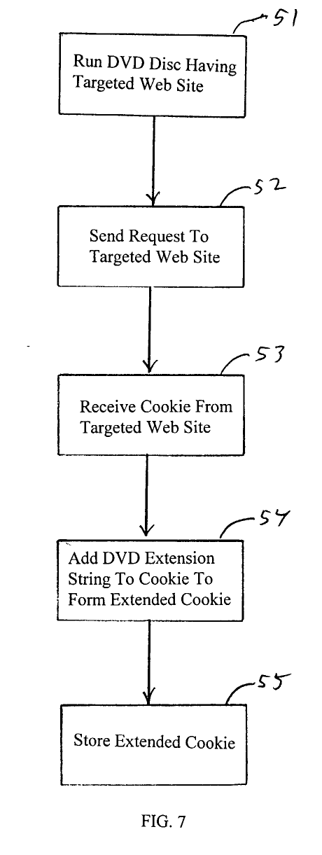

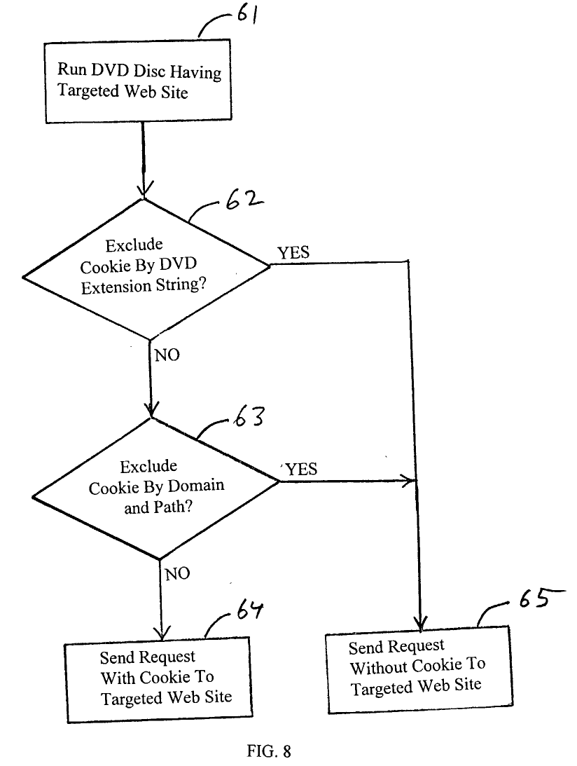

As seen in FIGS. 6A-6C, the DVD extension string 34 may be positioned in any spatial relationship with the normal cookie 32. The text specific content of the DVD extension string 34 may be viewed as a cookie attribute that is set by the computer code 97 and includes specific content associated with the DVD disc 11 that is running on the DVD device 99 of the WebDVD system 90. Examples of specific content associated with the DVD disc 11 will be provided infra. The computer code 97 uses the DVD extension string 34 as a filter to conditionally exclude access of web sites to the normal cookie 32 in accordance with the processing steps depicted in the flow charts of FIGS. 7 and 8.

FIG. 7 is a flow chart showing steps 51-55, which depicts adding a DVD extension string to a normal cookie during processing of the normal cookie, in accordance with embodiments of the present invention. In the following description of steps 51-55 of FIG. 7, the reader is referred to FIGS. 1 and 2 for drawing reference numerals referred to. In step 51, the WebDVD user runs the DVD disc 11 on the DVD device 99. The DVD disc 11 identifies the web site 82 as being targeted to communicate (e.g., send web pages) with the WebDVD system 90 in relation to the DVD Disc 11. Thus, the web site 82 is said to be targeted by the DVD disc 11. The DVD disc 11 is said to “run” (or be “running”) on the DVD device 99 if the DVD disc 11 is coupled to the DVD device 99 and sufficiently activated, such that DVD data or DVD subject content on the DVD disc 11 is instantaneously accessible to the computer code 97. In step 52, the computer code 97 sends a request to the web site 82, such as a request for transmission of one or more web pages of the web site 82. The web site 82 responds to the request by sending the requested web pages, and a cookie, to the WebDVD system 90. In step 53, the WebDVD system 90 receives the cookie sent by the web site 82. In step 54, the computer code 97 adds a DVD extension string to the cookie so received to form an extended cookie such as the extended cookie 41, 42, or 43 depicted in FIG. 6A, 6B, or 6C, respectively. In step 55, the computer code 97 stores the extended cookie in a storage area such as in the memory device 94. If prior to storing the extended cookie, a second cookie with the same DVD extension string already exists in the memory device 94, then the computer code 97 replaces the second cookie with the newly formed extended cookie. The DVD extension string of the extended cookie will be subsequently used to conditionally exclude access of web sites to the cookie as is illustrated in FIG. 8.

FIG. 8 is a flow chart showing steps 61-65, which depicts exclusion of access of a targeted web site to an extended cookie based on screening the DVD extension string of the cookie, in accordance with embodiments of the present invention. In the following description of steps 61-65 of FIG. 7, the reader is referred to FIGS. 1 and 2 for drawing reference numerals referred to. In step 61, the WebDVD user runs the DVD disc 11 on the DVD device 99. The DVD disc 11 identifies the web site 82 as being targeted to communicate (e.g., send web pages) with the WebDVD system 90 in relation to the DVD disc 11. However, the web site 82 may also be targeted by other DVD discs and the present invention will preclude (i.e. prevent) transmission of the cookie to the web site 82 if the associated extended cookie does not include the specific content associated with the DVD disc 11 as identified in the DVD extension string of the extended cookie. Accordingly, in step 62 the computer code 97 determines whether specific content associated with the DVD disc 11 matches the text in the extended cookie. If the specific content associated with the DVD disc 11 does not match the text in the extended cookie, then the computer code 97 sends a request, without the cookie, to the web site 82 as shown in step 65. If the specific content associated with the DVD disc 11 matches the text in the extended cookie, then the computer code 97 executes step 63. Step 63 determines whether to exclude access of the cookie from the web site 82 based on the Domain and Path attributes in the cookie, inasmuch as the Domain and Path attributes are known to a person of ordinary skill in the art to control access of cookies to web sites. If based on the Domain and Path attributes in the cookie the computer code 97 determines to exclude access of the cookie to the web site 82, then the computer code 97 sends a request, without the cookie, to the web site 82 as shown in step 65. If based on the Domain and Path attributes in the cookie the computer code 97 determines to not exclude access of the cookie to the web site 82, then the computer code 97 sends a request, with the cookie, to the web site 82 as shown in step 64.

If the computer code 97 sends the cookie to the web site 82, it is within the scope of the present invention to either: 1) send the extended cookie extended with the DVD extension string 34 cookie to the web site 82; or 2) send the cookie without the DVD extension string 34 (i.e., with the DVD extension string removed from the extended cookie) to the web site 82.

While particular process steps in a particular order are shown in FIG. 8, the process steps of FIG. 8 may be varied in substance and order as would be known or obvious to a person of ordinary skill in the art to determine whether to exclude access of the cookie to the web site 82. For example, steps 62 and 63 may be interchanged in order. Additionally, step 63 may be omitted. If step 63 is omitted, the decision of whether or not to send the cookie to the web site 82 will be determined solely the test in step 62, namely by consideration of whether the extended cookie includes the specific content associated with the DVD disc 11 as identified in the DVD extension string of the extended cookie.

The creation and adding of the DVD extension string 34 to the normal cookie 32 is implemented by software, namely the computer code 97 shown within the memory device 94 of FIG. 1. In the DVD player embodiment of the WebDVD system 90, described supra, the computer code 97 represents software that is specific to the WebDVD system 90 and the DVD device 92. In the integrated device embodiment of the WebDVD system 90, described supra, the computer code 97 represents software that is specific to the WebDVD system 90, the DVD device 92, and the electronics device 100. In the computer system embodiment, described supra, the computer code 97 may represent a web browser used by the computer system wherein the web browser has a capability of adding DVD extension strings to cookies and analyzing said DVD extension strings in accordance with the present invention, or the computer code 97 may alternatively represent special software inputted or downloaded into the computer system.

Depending on the embodiment, the WebDVD system 90 may store only extended cookies, or may store both normal cookies and extended cookies. If the WebDVD system 90 stores only extended cookies, then the WebDVD system 90 will comprise a single cookie file that includes said extended cookies and will not include any normal cookies. If the WebDVD system 90 stores both normal cookies and extended cookies, then the WebDVD system 90 will comprise either: a single cookie file that includes both the normal cookies and the extended cookies; or a first cookie file that includes only the normal cookies and a second cookie file that includes only the extended cookies. The WebDVD system 90 may combine or segregate normal cookies and extended cookies in other ways as would be apparent to one of ordinary skill in the art.

FIG. 9 is a table of specific content associated with the DVD disc 11, in accordance with embodiments of the present invention. Based on FIG. 9, the specific content associated with the DVD disc 11 and used in the DVD extension string may include, inter alia, any of the following specific content or any combination of the following specific content relating to the DVD disc 11 and appearing on, or associated with, the DVD disc 11: TitleID, PublisherID, PublisherGroupId, PublisherUniverseId, DiscID, DiscFamilyID, WebUniverseId, and a hashing function of data contained within the DVD disc 11.

The TitleID identifies the subject content of the DVD disc 11 and does not distinguish other DVD discs having the same subject content.

The PublisherID identifies the publisher of the DVD disc 11.

The PublisherGroupId identifies group of DVD publishers that have a direct or indirect relationship to the DVD disc 11. For example, the group may include the publisher of the DVD disc 11, and other members of the group may have a relationship to the publisher of the DVD disc 11.

The PublisherUniverseId identifies the totality of all publishers of DVD discs in existence. If the PublisherUniverseId is used, the cookie content should be standardized so as to be compatible with said totality of all publishers of DVD discs. The PublisherUniverseId may be viewed as a first version of a universal cookie for WebDVD.

The DiscID identifies the DVD disc 11 itself and distinguishes other DVD discs having the same TitleID. If a DiscID is not created on the DVD disc 11 during manufacture of the DVD disc 11, then a DiscID could be subsequently created on the DVD disc 11 if the DVD disc 11 is a rewritable disc.

The DiscFamilyID identifies a family of related DVD discs (i.e., a “Disc Family”) which are related in any manner such as by subject, author, publisher, year of publication, country of publication, etc.

The WebUniverseId identifies the totality of all web sites which are targeted by DVD discs. If the WebUniverseId is used, the cookie content should be standardized so as to be compatible with said totality of all web sites which are targeted by DVD discs. The WebUniverseId may be viewed as a second version of a universal cookie for WebDVD.

A hashing function of data contained within the DVD disc 11 may be generated from any “statistically unique” data appearing on the DVD disc 11. The result of the hashing function becomes the specific content of the DVD extension string. Two data items are “statistically unique” relative to a hashing function if the probability is small (e.g., less than 10⁻⁴) that the hashing function will produce identical results for the two data items. Possible candidates for such statistically unique data include: data pointers located within tables such as the unique number in the Volume Set Identifier field in the Primary Volume Descriptor table; fields in files which define content and menus such as in ifo files; cell elapse time; start or end addresses of cells; start address of a video object unit (VOBU); etc.

Various groups of the preceding parameters which may be included in the DVD extension string may be characterized as a hierarchy of parameters. Each such hierarchy comprises a sequence of parameters starting with the most general parameter of the sequence and ending with the least general parameter of the sequence. A first example of such a hierarchy is: WebUniverseId, PublisherUniverseId, PublisherGroupId, and PublisherID. A second example of such a hierarchy is: WebUniverseID, DiscFamilyID, TitleId, and DiscID. Each parameter in a given hierarchy exits at a different level of the hierarchy. For the second example of a hierarchy, stated supra, the parameters WebUniverseID, DiscFamilyID, TitleId, and DiscID respectively exist at a first level, second level, third level, and fourth level of the second hierarchy. In the arrangement from highest to lowest level, the first level of the hierarchy is defined to be at a higher level than the second level of the hierarchy, the second level of the hierarchy is defined to be at a higher level than the third level of the hierarchy, etc. The DVD extension string may comprise one level in the given hierarchy. The DVD extension string may alternatively comprise a combination of a level in a first hierarchy and a level in a second hierarchy, as for example in a combination of PublisherId and TitleId. Although it is within the scope of the present invention to include in the DVD extension string a combination of different levels of the same hierarchy, use of such a combination of different levels of the same hierarchy is logically equivalent to use of only the highest level of said different levels of the same hierarchy, so that inclusion of lower levels of the same hierarchy is unnecessary.

The DVD extension string may include, inter alia, any of the following specific content or any combination of the following specific content relating to the DVD disc 11 and appearing on, or associated with, the DVD disc 11: TitleID, PublisherID, PublisherGroupId, PublisherUniverseId, DiscID, DiscFamilyID, WebUniverseId, and a hashing function of data contained within the DVD disc 11.

The following list provides examples of parameters or parameter combinations within a DVD extension string:

the TitleID and PublisherID of the DVD disc 11;

the TitleID of the DVD disc 11;

the PublisherID of the DVD disc 11;

the PublisherGroupID of the DVD disc 11;

the PublisherUniverseId on the DVD disc 11;

the DiscID of the DVD disc 11;

the DiscFamilyID of the DVD disc 11;

the WebUniverseId on the DVD disc 11; and

a hashing function of data contained within the DVD disc 11.

The user of the WebDVD system 90 may be permitted to specify or select any individual, or combination of, the preceding parameters for insertion in the DVD extension string. There may be a default individual or combination of the preceding parameters for insertion in the DVD extension string. The user may select a portion of the specific content to be included within the DVD extension string, wherein the portion may consist of the entire specific content to be included within the DVD extension string. An algorithm, or any other method, may be used to specify any individual or combination of the preceding parameters for insertion in the DVD extension string.

While a cookie of the present invention may be embedded within a cookie file that is stored in a readable memory device of the WebDVD system 90, the cookie of the present invention may be stored in any manner in any readable memory device of the WebDVD system 90. For example, the cookie of the present invention may be stored in, inter alia, a file, table, array, cached data, etc. in any readable memory device of the WebDVD system 90.

While the embodiments described herein are expressed in terms of a DVD disc (e.g., the DVD disc 11 of FIGS. 2 and 3), the present invention, as illustrated herein by the DVD disc 11, is not limited to DVD discs. The scope of the present invention generally includes any medium having any physical disc format (e.g. CD, DVD, Blu-ray, etc.), including ROM, Write once, and Rewritable discs. The present invention generally applies to discs that include different application formats (e.g. video, audio, games, etc.).

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for extending a cookie, comprising:
running, by the WebDVD system, a DVD disc on a DVD device that is comprised by the WebDVD system, wherein the DVD device is linked by a communication link to a web site that is targeted by the DVD disc;
receiving during said running, by the WebDVD system from the web site, a cookie-generation command to generate a cookie;
generating, by the WebDVD system, the cookie as specified by the cookie-generation command;
adding, by the WebDVD system, a DVD extension string to the cookie to form an extended cookie, wherein the DVD extension string includes specific content associated with the DVD disc; and
storing the extended cookie in a readable memory device comprised by the WebDVD system.

2. The method of claim 1, wherein said storing comprises replacing a first cookie in the readable memory device with the extended cookie if the first cookie includes the specific content associated with the DVD disc.

3. The method of claim 1, further comprising selecting, by a user of the DVD system, a portion of the specific content to be included within the DVD extension string.

4. The method of claim 1, wherein the specific content associated with the DVD disc comprises the TitleID and PublisherID of the DVD disc.

5. The method of claim 1, wherein the specific content associated with the DVD disc comprises the TitleID of the DVD disc.

6. The method of claim 1, wherein the specific content associated with the DVD disc comprises the PublisherID of the DVD disc or the PublisherGroupID of the DVD disc.

7. The method of claim 1, wherein the specific content associated with the DVD disc comprises a PublisherUniverseID or a WebUniverseID.

8. The method of claim 1, wherein the specific content associated with the DVD disc comprises the DiscID of the DVD disc.

9. The method of claim 1, wherein the specific content associated with the DVD disc comprises the DiscFamilyId of a Disc Family to which the DVD disc belongs.

10. The method of claim 1, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

11. The method of claim 1, wherein the specific content associated with the DVD disc comprises a hashing function of data contained within the DVD disc.

12. The method of claim 1, wherein the DVD extension string is a DVD prefix extension string.

13. The method of claim 1, wherein the DVD extension string is a DVD suffix extension string.

14. The method of claim 1, wherein the DVD extension string is a DVD inner extension string.

15. The method of claim 1, wherein the WebDVD system comprises a WebDVD player that includes the DVD device.

16. The method of claim 15, wherein the WebDVD player includes a display device for displaying data relating to the DVD disc.

17. The method of claim 16, wherein the display device is external to the WebDVD player.

18. The method of claim 17, wherein the display device is a television.

19. The method of claim 1, wherein the WebDVD system comprises a computer system that couples the DVD device to the communication link, and wherein the DVD device is external to the computer system.

20. The method of claim 1, wherein the WebDVD system comprises a computer system that couples the DVD device to the communication link, and wherein the DVD device is within the computer system.

21. The method of claim 1, wherein the WebDVD system further includes an electronics device that is adapted to operate in conjunction with the DVD device.

22. The method of claim 21, wherein a consumer electronics device comprises the electronics device coupled to the DVD device.

23. The method of claim 22, wherein the consumer electronics device comprises a video game player.

24. The method of claim 22, wherein the consumer electronics device comprises a DVD-VHS device.

25. The method of claim 1, wherein the communication link comprises the Internet.

26. A method for screening a cookie, comprising:
retrieving a cookie from a readable memory device of a WebDVD system that includes a DVD device, wherein the cookie includes a DVD extension string; and
precluding transmission of the cookie to a web site targeted by a DVD disc that is running on the DVD device if the DVD extension string does not includes specific content associated with the DVD disc, wherein the DVD device is linked by a communication link to the web site.

27. The method of claim 26, further comprising transmitting the cookie to the web site if the DVD extension string includes the specific content associated with the DVD disc.

28. The method of claim 26, wherein the specific content associated with the DVD disc comprises the TitleID and PublisherID of the DVD disc.

29. The method of claim 26, wherein the specific content associated with the DVD disc comprises the TitleID of the DVD disc.

30. The method of claim 26, wherein the specific content associated with the DVD disc comprises the PublisherID of the DVD disc.

31. The method of claim 26, wherein the specific content associated with the DVD disc comprises the PublisherGroupID of the DVD disc.

32. The method of claim 26, wherein the specific content associated with the DVD disc comprises a PublisherUniverseID or a WebUniverseID.

33. The method of claim 26, wherein the specific content associated with the DVD disc comprises the DiscID of the DVD disc.

34. The method of claim 26, wherein the specific content associated with the DVD disc comprises the DiscFamilyId of a Disc Family to which the DVD disc belongs.

35. The method of claim 26, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

36. The method of claim 26, wherein the specific content associated with the DVD disc comprises a hashing function of data contained within the DVD disc.

37. The method of claim 26, wherein the DVD extension string is a DVD prefix extension string.

38. The method of claim 26, wherein the DVD extension string is a DVD suffix extension string.

39. The method of claim 26, wherein the DVD extension string is a DVD inner extension string.

40. The method of claim 26, wherein the WebDVD system comprises a WebDVD player that includes the DVD device.

41. The method of claim 40, wherein the WebDVD player includes a display device for displaying data relating to the DVD disc.

42. The method of claim 41, wherein the display device is external to the WebDVD player.

43. The method of claim 42, wherein the display device is a television.

44. The method of claim 26, wherein the WebDVD system comprises a computer system that couples the DVD device to the communication link, and wherein the DVD device is external to the computer system.

45. The method of claim 26, wherein the WebDVD system comprises a computer system that couples the DVD device to the communication link, and wherein the DVD device is within the computer system.

46. The method of claim 26, wherein the WebDVD system further includes an electronics device that is adapted to operate in conjunction with the DVD device.

47. The method of claim 45, wherein a consumer electronics device comprises the electronics device coupled to the DVD device.

48. The method of claim 47, wherein the consumer electronics device comprises a video game player.

49. The method of claim 47, wherein the consumer electronics device comprises a DVD-VHS device.

50. The method of claim 26, wherein the communication link comprises the Internet.

51. A network, comprising a WebDVD system for extending a cookie, wherein the WebDVD system is adapted to:
run a DVD disc on a DVD device that is comprised by the WebDVD system, wherein the DVD device is linked by a communication link to a web site that is targeted by the DVD disc;
receive from the web site, while the DVD disc is running on the DVD device, a cookie-generation command to generate a cookie;
generate the cookie as specified by the cookie-generation command;
add a DVD extension string to the cookie to form an extended cookie, wherein the DVD extension string includes specific content associated with the DVD disc; and
store the extended cookie in a readable memory device comprised by the WebDVD system.

52. The network of claim 51, wherein to store the extended cookie comprises to replace a first cookie in the readable memory device with the extended cookie if the first cookie includes the specific content associated with the DVD disc.

53. The network of claim 51, wherein the WebDVD system is further adapted to have a user of the DVD system select a portion of the specific content to be included within the DVD extension string.

54. The network of claim 51, wherein the specific content associated with the DVD disc comprises the TitleID and PublisherID of the DVD disc.

55. The network of claim 51, wherein the specific content associated with the DVD disc comprises the TitleID of the DVD disc.

56. The network of claim 51, wherein the specific content associated with the DVD disc comprises the PublisherID of the DVD disc or the PublisherGroupID of the DVD disc.

57. The network of claim 51, wherein the specific content associated with the DVD disc comprises a PublisherUniverseID or a WebUniverseID.

58. The network of claim 51, wherein the specific content associated with the DVD disc comprises the DiscID of the DVD disc.

59. The network of claim 51, wherein the specific content associated with the DVD disc comprises the DiscFamilyId of a Disc Family to which the DVD disc belongs.

60. The network of claim 51, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

61. The network of claim 51, wherein the specific content associated with the DVD disc comprises a hashing function of data contained within the DVD disc.

62. The network of claim 51, wherein the DVD extension string is a DVD prefix extension string.

63. The network of claim 51, wherein the DVD extension string is a DVD suffix extension string.

64. The network of claim 51, wherein the DVD extension string is a DVD inner extension string.

65. The network of claim 51, wherein the WebDVD system comprises a WebDVD player that includes the DVD device.

66. The network of claim 65, wherein the WebDVD player includes a display device for displaying data relating to the DVD disc.

67. The network of claim 66, wherein the display device is external to the WebDVD player.

68. The network of claim 67, wherein the display device is a television.

69. The network of claim 51, wherein the WebDVD system comprises a computer system that couples the DVD device to the communication link, and wherein the DVD device is external to the computer system.

70. The network of claim 51, wherein the WebDVD system comprises a computer system that couples the DVD device to the communication link, and wherein the DVD device is within the computer system.

71. The network of claim 51, wherein the WebDVD system further includes an electronics device that is adapted to operate in conjunction with the DVD device.

72. The network of claim 71, wherein a consumer electronics device comprises the electronics device coupled to the DVD device.

73. The network of claim 72, wherein the consumer electronics device comprises a video game player.

74. The network of claim 72, wherein the consumer electronics device comprises a DVD-VHS device.

75. The network of claim 51, wherein the communication link comprises the Internet.

76. A network, comprising a WebDVD system for screening a cookie, wherein the WebDVD system is adapted to:
retrieve a cookie from a readable memory device of a WebDVD system that includes a DVD device, wherein the cookie includes a DVD extension string; and
preclude transmission of the cookie to a web site targeted by a-DVD disc that is running on the DVD device if the DVD extension string does not includes specific content associated with the DVD disc, wherein the DVD device is linked by a communication link to the web site.

77. The network of claim 76, wherein the WebDVD system is further adapted to transmit the cookie to the web site if the DVD extension string includes the specific content associated with the DVD disc.

78. The network of claim 76, wherein the specific content associated with the DVD disc comprises the TitleID and PublisherID of the DVD disc.

79. The network of claim 76, wherein the specific content associated with the DVD disc comprises the TitleID of the DVD disc.

80. The network of claim 76, wherein the specific content associated with the DVD disc comprises the PublisherID of the DVD disc.

81. The network of claim 76, wherein the specific content associated with the DVD disc comprises the PublisherGroupID of the DVD disc.

82. The network of claim 76, wherein the specific content associated with the DVD disc comprises a PublisherUniverseID or a WebUniverseID.

83. The network of claim 76, wherein the specific content associated with the DVD disc comprises the DiscID of the DVD disc.

84. The network of claim 76, wherein the specific content associated with the DVD disc comprises the DiscFamilyId of a Disc Family to which the DVD disc belongs.

85. The network of claim 76, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

86. The network of claim 76, wherein the specific content associated with the DVD disc comprises a hashing function of data contained within the DVD disc.

87. The network of claim 76, wherein the DVD extension string is a DVD prefix extension string.

88. The network of claim 76, wherein the DVD extension string is a DVD suffix extension string.

89. The network of claim 76, wherein the DVD extension string is a DVD inner extension string.

90. The network of claim 76, wherein the WebDVD system comprises a WebDVD player that includes the DVD device.

91. The network of claim 90, wherein the WebDVD player includes a display device for displaying data relating to the DVD disc.

92. The network of claim 91, wherein the display device is external to the WebDVD player.

93. The network of claim 92, wherein the display device is a television.

94. The network of claim 76, wherein the WebDVD system comprises a computer system that couples the DVD device to the communication link, and wherein the DVD device is external to the computer system.

95. The network of claim 76, wherein the WebDVD system comprises a computer system that couples the DVD device to the communication link, and wherein the DVD device is within the computer system.

96. The network of claim 76, wherein the WebDVD system further includes an electronics device that is adapted to operate in conjunction with the DVD device.

97. The network of claim 96, wherein a consumer electronics device comprises the electronics device coupled to the DVD device.

98. The network of claim 97, wherein the consumer electronics device comprises a video game player.

99. The network of claim 97, wherein the consumer electronics device comprises a DVD-VHS device.

100. The network of claim 76, wherein the communication link comprises the Internet.

101. A computer program product, comprising a computer usable medium having a computer readable program code embodied therein for extending a cookie, said computer code embedded within a readable storage device of a WebDVD system, said computer code comprising an algorithm adapted to:
run a DVD disc on a DVD device that is comprised by the WebDVD system, wherein the DVD device is linked by a communication link to a web site that is targeted by the DVD disc;
receive from the web site, while the DVD disc is running on the DVD device, a cookie-generation command to generate a cookie;
generate the cookie as specified by the cookie-generation command;
add a DVD extension string to the cookie to form an extended cookie, wherein the DVD extension string includes specific content associated with the DVD disc; and
store the extended cookie in a readable memory device comprised by the WebDVD system.

102. The computer program product of claim 101, wherein to store the extended cookie comprises to replace a first cookie in the readable memory device with the extended cookie if the first cookie includes the specific content associated with the DVD disc.

103. The computer program product of claim 101, wherein the algorithm is further adapted to have a user of the DVD system select a portion of the specific content to be included within the DVD extension string.

104. The computer program product of claim 101, wherein the specific content associated with the DVD disc comprises the TitleID and PublisherID of the DVD disc.

105. The computer program product of claim 101, wherein the specific content associated with the DVD disc comprises the TitleID of the DVD disc.

106. The computer program product of claim 101, wherein the specific content associated with the DVD disc comprises the PublisherID of the DVD disc or the PublisherGroupID of the DVD.

107. The computer program product of claim 101, wherein the specific content associated with the DVD disc comprises a PublisherUniverseID or a WebUniverseID.

108. The computer program product of claim 101, wherein the specific content associated with the DVD disc comprises the DiscID of the DVD disc.

109. The computer program product of claim 101, wherein the specific content associated with the DVD disc comprises the DiscFamilyId of a Disc Family to which the DVD disc belongs.

110. The computer program product of claim 101, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

111. The computer program product of claim 101, wherein the specific content associated with the DVD disc comprises a hashing function of data contained within the DVD disc.

112. The computer program product of claim 101, wherein the DVD extension string is a DVD prefix extension string.

113. The computer program product of claim 101, wherein the DVD extension string is a DVD suffix extension string.

114. The computer program product of claim 101, wherein the DVD extension string is a DVD inner extension string.

115. The computer program product of claim 101, wherein the WebDVD system comprises a WebDVD player that includes the DVD device.

116. The computer program product of claim 115, wherein the WebDVD player includes a display device for displaying data relating to the DVD disc.

117. The computer program product of claim 116, wherein the display device is external to the WebDVD player.

118. The computer program product of claim 117, wherein the display device is a television.

119. The computer program product of claim 101, wherein the WebDVD system comprises a computer system that couples the DVD device to the communication link, and wherein the DVD device is external to the computer system.

120. The computer program product of claim 101, wherein the WebDVD system comprises a computer system that couples the DVD device to the communication link, and wherein the DVD device is within the computer system.

121. The computer program product of claim 101, wherein the WebDVD system further includes an electronics device that is adapted to operate in conjunction with the DVD device.

122. The computer program product of claim 121, wherein a consumer electronics device comprises the electronics device coupled to the DVD device.

123. The computer program product of claim 122, wherein the consumer electronics device comprises a video game player.

124. The computer program product of claim 122, wherein the consumer electronics device comprises a DVD-VHS device.

125. The computer program product of claim 101, wherein the communication link comprises the Internet.

126. A computer program product, comprising a computer usable medium having a computer readable program code embodied therein for screening a cookie, said computer code embedded within a readable storage device of a WebDVD system, said computer code comprising an algorithm adapted to:
retrieve a cookie from a readable memory device of a WebDVD system that includes a DVD device, wherein the cookie includes a DVD extension string; and
preclude transmission of the cookie to a web site targeted by a DVD disc that is running on the DVD device if the DVD extension string does not includes specific content associated with the DVD disc, wherein the DVD device is linked by a communication link to the web site.

127. The computer program product of claim 126, wherein the algorithm is further adapted to transmit the cookie to the web site if the DVD extension string includes the specific content associated with the DVD disc.

128. The computer program product of claim 126, wherein the specific content associated with the DVD disc comprises the TitleID and PublisherID of the DVD disc.

129. The computer program product of claim 126, wherein the specific content associated with the DVD disc comprises the TitleID of the DVD disc.

130. The computer program product of claim 126, wherein the specific content associated with the DVD disc comprises the PublisherID of the DVD disc.

131. The computer program product of claim 126, wherein the specific content associated with the DVD disc comprises the PublisherGroupID of the DVD disc.

132. The computer program product of claim 126, wherein the specific content associated with the DVD disc comprises a PublisherUniverseID or a WebUniverseID.

133. The computer program product of claim 126, wherein the specific content associated with the DVD disc comprises the DiscID of the DVD disc.

134. The computer program product of claim 126, wherein the specific content associated with the DVD disc comprises the DiscFamilyId of a Disc Family to which the DVD disc belongs.

135. The computer program product of claim 126, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

136. The computer program product of claim 126, wherein the specific content associated with the DVD disc comprises a hashing function of data contained within the DVD disc.

137. The computer program product of claim 126, wherein the DVD extension string is a DVD prefix extension string.

138. The computer program product of claim 126, wherein the DVD extension string is a DVD suffix extension string.

139. The computer program product of claim 126, wherein the DVD extension string is a DVD inner extension string.

140. The computer program product of claim 126, wherein the WebDVD system comprises a WebDVD player that includes the DVD device.

141. The computer program product of claim 140, wherein the WebDVD player includes a display device for displaying data relating to the DVD disc.

142. The computer program product of claim 141, wherein the display device is external to the WebDVD player.

143. The computer program product of claim 142, wherein the display device is a television.

144. The computer program product of claim 126, wherein the WebDVD system comprises a computer system that couples the DVD device to the communication link, and wherein the DVD device is external to the computer system.

145. The computer program product of claim 126, wherein the WebDVD system comprises a computer system that couples the DVD device to the communication link, and wherein the DVD device is within the computer system.

146. The computer program product of claim 126, wherein the WebDVD system further includes an electronics device that is adapted to operate in conjunction with the DVD device.

147. The computer program product of claim 146, wherein a consumer electronics device comprises the electronics device coupled to the DVD device.

148. The computer program product of claim 147, wherein the consumer electronics device comprises a video game player.

149. The computer program product of claim 147, wherein the consumer electronics device comprises a DVD-VHS device.

150. The computer program product of claim 126, wherein the communication link comprises the Internet.

151. A cookie embedded within a readable memory device of a WebDVD system that includes a DVD device on which a DVD disc is running, said cookie comprising a DVD extension string, wherein the cookie is not to be transmitted to a web site if the DVD extension string does not include specific content associated with the DVD disc, and wherein the web site is targeted by the DVD disc and is linked by a communication link to the DVD disc.

152. The cookie of claim 1, wherein the cookie is to be transmitted to the web site if the DVD extension string includes the specific content associated with the DVD disc.

153. The cookie of claim 1, wherein the specific content associated with the DVD disc comprises the TitleID and PublisherID of the DVD disc.

154. The cookie of claim 1, wherein the specific content associated with the DVD disc comprises the TitleID of the DVD disc.

155. The cookie of claim 1, wherein the specific content associated with the DVD disc comprises the PublisherID of the DVD disc.

156. The cookie of claim 1, wherein the specific content associated with the DVD disc comprises the PublisherGroupID of the DVD disc.

157. The cookie of claim 1, wherein the specific content associated with the DVD disc comprises a PublisherUniverseID or a WebUniverseID.

158. The cookie of claim 1, wherein the specific content associated with the DVD disc comprises the DiscID of the DVD disc.

159. The cookie of claim 1, wherein the specific content associated with the DVD disc comprises the DiscFamilyId of a Disc Family to which the DVD disc belongs.

160. The cookie of claim 1, wherein the specific content associated with the DVD disc comprises an ID selected from the group consisting of a TitleID, a PublisherID, a PublisherGroupId, a PublisherUniverseId, a DiscID, a DiscFamilyID, a WebUniverseId, and a combination thereof.

161. The cookie of claim 1, wherein the specific content associated with the DVD disc comprises a hashing function of data contained within the DVD disc.

162. The cookie of claim 1, wherein the DVD extension string is a DVD prefix extension string.

163. The cookie of claim 1, wherein the DVD extension string is a DVD suffix extension string.

164. The cookie of claim 1, wherein the DVD extension string is a DVD inner extension string.

165. The cookie of claim 1, wherein the WebDVD system comprises a WebDVD player that includes the DVD device.

166. The cookie of claim 165, wherein the WebDVD player includes a display device for displaying data relating to the DVD disc.

167. The cookie of claim 166, wherein the display device is external to the WebDVD player.

168. The cookie of claim 167, wherein the display device is a television.

169. The cookie of claim 1, wherein the WebDVD system comprises a computer system that couples the DVD device to the communication link, and wherein the DVD device is external to the computer system.

170. The cookie of claim 1, wherein the WebDVD system comprises a computer system that couples the DVD device to the communication link, and wherein the DVD device is within the computer system.

171. The cookie of claim 1, wherein the WebDVD system further includes an electronics device that is adapted to operate in conjunction with the DVD device.

172. The cookie of claim 21, wherein a consumer electronics device comprises the electronics device coupled to the DVD device.

173. The cookie of claim 172, wherein the consumer electronics device comprises a video game player.

174. The cookie of claim 172, wherein the consumer electronics device comprises a DVD-VHS device.

175. The cookie of claim 1, wherein the communication link comprises the Internet.
